(19) United States
(12) Patent Application Publication
(10) Pub. No.: US 2006/0237955 A1
(43) Pub. Date: Oct. 26, 2006

(54) Method and device for deactivating a pyrotechnic actuator in a motor vehicle

(75) Inventor: Thomas Gornig, Markt Indersdorf (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 10/559,352

(22) PCT Filed: Nov. 8, 2003
(86) PCT No.: PCT/DE03/03710

§ 371 Date: May 31, 2006

(30) Foreign Application Priority Data
Jun. 4, 2003 (DE) 103254943

(51) Int. Cl. B60R 21/01

(52) U.S. Cl. 280/735

(57) ABSTRACT

The disclosed method relates to a procedure for deactivating a pyrotechnical actuator (10) from a vehicle. A diagnostics mode of a control unit (14) of the pyrotechnical actuator (10) is activated using a diagnostics unit (12). Accordingly, a disposal mode in the control unit (14) is then activated and the pyrotechnical actuator (10) is fired in this mode.

### BACKGROUND OF THE INVENTION

The invention relates to a procedure for deactivating a pyrotechnical actuator from a vehicle including activating a diagnostic mode of a control unit, activating a disposal mode in the control unit and firing the pyrotechnical actuator in the disposal mode.

In the field of automobile technology, increasing use is being made of safety appliances containing pyrotechnical actuators, such as airbags and belt tightening systems. Since they are explosive, actuators of this type are very dangerous when not used in the correct manner, and must therefore be disposed of separately when a vehicle is scrapped.

For this purpose, safety appliances with pyrotechnical actuators are generally removed from a vehicle which is to be scrapped, and are detonated using an external device before dismantling continues. Here, the detonation procedure is an uncontrolled and in some circumstances, a highly dangerous procedure. In addition, removing the actuators is an expensive operation in terms of time and money, since it is necessary for specialist staff to conduct the procedure.

In the case of an airbag, it is generally not possible to trigger via the airbag control unit, since the safety strategies which use a safing or trigger sensor do not permit detonation to be conducted without an external acceleration signal.

The EP 0995646 B1 discloses a deactivation procedure for pyrotechnical actuators in a vehicle wherein a code signal for triggering actuators can be entered externally, for example via a diagnostic or bus interface. When the code signal entered matches the code signal stored in the vehicle, the actuators are triggered in unison. Here, knowledge of the code is sufficient to trigger the actuators. A recommendation is made to further increase security through an electromechanical manipulation of the on-board electrical system of the vehicle in preparation for the triggering procedure, for example by applying a hardware signal to a sensor connection. However, in this case, it is also only necessary to have knowledge of the code signal and the manipulation of the on-board electrical system to be able to trigger the actuators.

### SUMMARY OF THE INVENTION

The object of the present invention is to recommend a procedure and a device for deactivating a pyrotechnical actuator from a vehicle which further increase security against unauthorised triggering of the actuator.

This object is attained by a procedure and a device for deactivating a pyrotechnical actuator from a vehicle with the features described below.

A key aspect of the invention is the introduction of an additional mode in a control unit of a pyrotechnical actuator, which enables the secure, controlled and logged triggering of an actuator. This additional mode is referred to hereafter as the “disposal mode”, since controlled triggering is usually necessary when the actuator is disposed of, i.e. when the vehicle is scrapped.

The invention now relates to a procedure for deactivating a pyrotechnical actuator from a vehicle, wherein a diagnostics unit is used to activate a diagnostics mode of a control unit of the pyrotechnical actuator. According to the invention, a disposal mode in the control unit is subsequently activated, and the pyrotechnical actuator is fired in this mode. Only when the disposal mode is activated is it possible to fire or trigger the actuator. As a result, the level of security is higher than when the simple procedure of entering a code is used.

In disposal mode, a master controller in the control unit preferably receives a first codeword to fire the pyrotechnical actuator from the diagnostics unit, which it transfers to a slave controller which is designed to release and lock a firing path. Since in present-day control units for pyrotechnical actuators, such as those used in airbag systems, a master and slave controller is used to attain a specific level of security, rather than safing or trigger signals, the controlled firing procedure can be controlled and monitored by the two controllers.

Specifically, the slave controller requests a second codeword from the master controller in order to fire the pyrotechnical actuator, which the master controller requests from the diagnostics unit. The use of a second codeword can further increase the level of security in disposal mode.

For security reasons, the master controller may only request the second codeword from the diagnostics unit during a prespecified time period.

Specifically, the disposal mode is re-activated in cases where the diagnostics unit fails to transfer a second codeword to the master controller within the prespecified time period.

The slave controller then checks the first and second codeword, specifically linking the two codewords with each other, and tests the validity of the result. This makes it possible to prevent one or two invalid codewords from being entered.

After the two codewords have been checked successfully, the slave controller can then transmit a release signal to the master controller.

The master controller can then in turn send an acknowledgement of the release signal to the slave controller, and release the firing path for the pyrotechnical actuator.

Specifically, the slave controller releases the firing path for the pyrotechnical actuator after the master controller has acknowledged the release signal.

Typically, the master controller monitors firing circuits for firing the pyrotechnical actuator to ensure that firing is conducted correctly, and logs the firing of the pyrotechnical actuator.

A system which incorporates the fired pyrotechnical actuator, in particular an airbag system, can then be locked so that it can no longer be used.

In order to log the deactivation procedure, a date and/or time stamp and/or an identification, in particular an identification number for the diagnostics unit, can be stored in the system when the system is locked. This makes it possible to retrace the deactivation of the pyrotechnical actuator at a later date.

The diagnostics unit preferably issues a protocol after the system has been locked, and specifically prints it out, for example using a printer installed in, or connected to, the diagnostics unit; the protocol comprises a vehicle serial number, a system serial number and/or a system status with the pyrotechnical actuator, and is preferably used for archiving and providing evidence of the deactivation procedure.

Furthermore, the invention relates to a device for deactivating a pyrotechnical actuator from a vehicle, with a control unit to trigger the pyrotechnical actuator and a diagnostics unit which is designed to activate a diagnostics mode in the control unit of the pyrotechnical actuator. According to the invention, the control device comprises a disposal mode which is provided in order to conduct the controlled firing of the pyrotechnical actuator; the diagnostics unit is designed to activate the disposal mode in the control unit of the pyrotechnical actuator.

Specifically, the control unit and the diagnostics unit are designed to conduct the procedure described above in accordance with the invention.

The control unit and the diagnostics unit are preferably equipped with a program to conduct a procedure in accordance with the invention; specifically, the software in the control unit and the diagnostics unit is supplemented by a disposal mode. Usually, diagnostics units and control units already available can be extended by updating their operating software according to the invention.

Furthermore, the invention relates to an airbag system with a pyrotechnical actuator to activate an airbag and a control unit for controlling an airbag system, specifically for monitoring and firing the pyrotechnical actuator. The control unit comprises a disposal mode for the controlled firing of the pyrotechnical actuator, which can be activated by a diagnostics unit and which is extended in accordance with the invention in order to conduct the procedure described above.

Further advantages and potential applications of the present invention result from the description below in connection with the exemplary embodiments shown in the drawings.

### BRIEF DESCRIPTION OF THE DRAWINGS

The terms and assigned reference numerals given in the list are used in the description, in the claims, in the summary and in the drawings.

In the drawings:

FIG. 1 shows an exemplary embodiment of a device for disposing of an airbag system in accordance with the invention, and

FIG. 2 shows a exemplary embodiment of a procedure for disposing of the airbag system shown in FIG. 1 in accordance with the invention

### DETAILED DESCRIPTION OF THE DRAWINGS

Hereafter, the same reference numerals may be used to designate the same elements and/or elements with the same function.

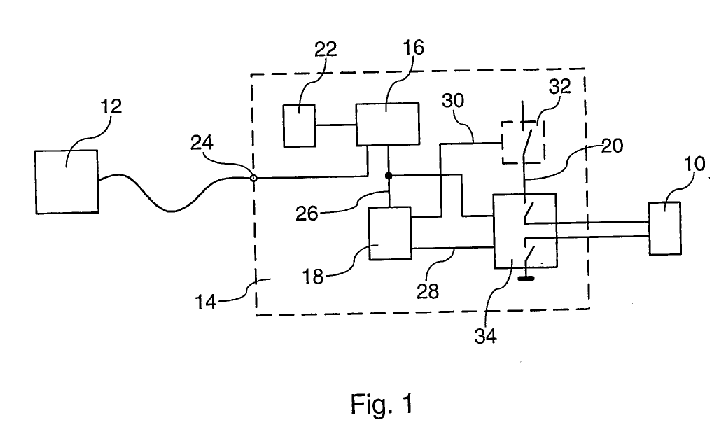

In FIG. 1, a primer 10 is used as a pyrotechnical actuator in an airbag system. The primer 10 is controlled by a control unit 14, the communication system of which can in turn be connected with a diagnostics unit 12 for testing and triggering or firing the primer 10. For this purpose, the control unit 14 comprises a diagnostic interface 24 which can, for example, be a known OBD (on-board diagnostic) interface.

The control unit also comprises a master microprocessor 16 (master controller) and a slave microprocessor 18 (slave controller), which are both fitted in the control unit 14 in the known manner in order to attain a high level of security, and which work together accordingly. The communications systems of both processors, 16 and 18, are connected with each other via a data bus 26. The master microprocessor 16 is also connected with the diagnostics interface 24, via which it can communicate with the diagnostics unit 12, specifically being able to receive control commands and transmit diagnostics data.

The slave microprocessor 18 is used predominantly to release the firing path 20 in the control unit 14. The firing path 20 contains a switch 32 which acts as the main switch and a driver stage 34, which is used to drive the primer 10, i.e. to close the firing path 20. The firing path 20 connects a firing voltage source (not shown) with the primer 10. When the switch 32 is closed and the driver stage 34 is activated, the firing path 20 is closed and the primer 10 is fired by the firing voltage which is applied. The switch 32 is controlled by a second activation signal 30 and the driver stage 34 is controlled by a first activation signal 28 in the slave microprocessor. Furthermore, the driver stage 34 is controlled by data on the data bus 26, which is provided by the master microprocessor 16.

In normal operating mode, the acceleration of a vehicle in which an airbag has been installed is measured using an acceleration sensor 22 in the control unit 14. If a particularly high negative acceleration is measured, the master microprocessor 16 causes the primer 10 to be fired or triggered and the airbag to be activated, insofar as the slave microprocessor 18 has released the first and second activation signal 28 and 30. The two activation signals 28 and 30 are released when the slave microprocessor 18 has detected a fault in the operation of the master microprocessor 16.

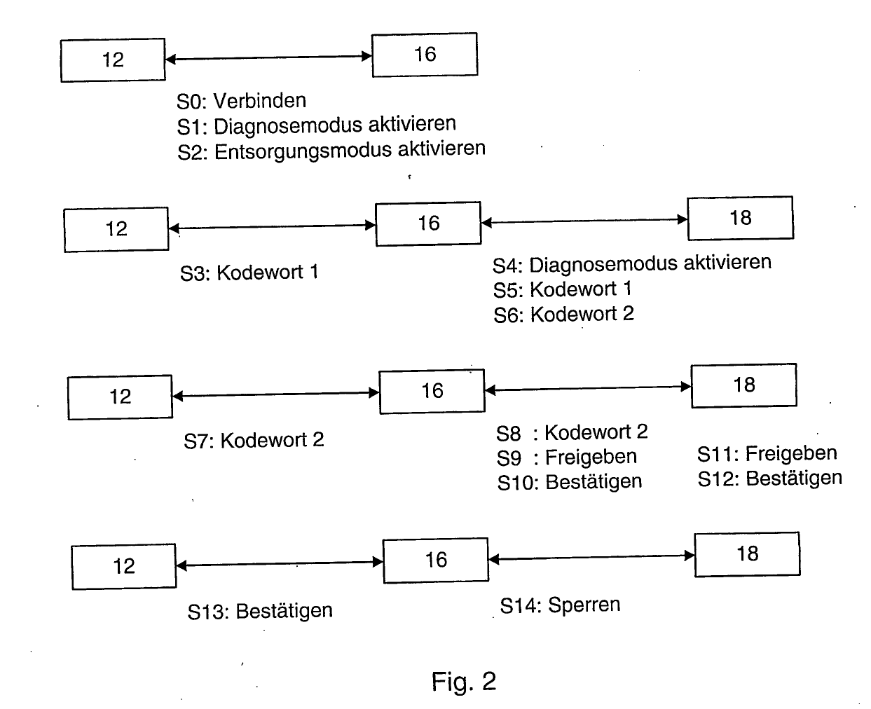

In order to dispose of the airbag system, it is necessary to fire the primer 10 in a controlled manner. Since no acceleration signal from an acceleration sensor is available, the firing is initiated by the diagnostics unit 12. The firing procedure using the diagnostics unit 12 is shown in FIG. 2, wherein the communication sequence between the diagnostics unit 12, the master microprocessor 16 and the slave microprocessor 18 is explained and represented.

In one step S0, the diagnostics unit is connected with the master microprocessor 16, i.e. the diagnostics unit initiates a communication connection with the master microprocessor 16.

The diagnostics unit 12 then activates a diagnostics mode in the control unit 14, or more precisely, in the master microprocessor 16 (step S1). Then a disposal mode is activated in the control unit 14 and the master microprocessor 16 by the diagnostics unit 12, wherein controlled firing and blocking of the airbag system for subsequent use is possible.

In disposal mode, the diagnostics unit 12 transmits a first codeword in one step S3 to the master microprocessor 16, which has requested said codeword. The first codeword can be an unequivocal codeword which has been assigned to the airbag system, or a central codeword. It can be entered on the diagnostics unit 12 using a keyboard, or can be stored in said diagnostics unit.

When the first codeword has been checked and released by the master microprocessor 16, said microprocessor then also activates the disposal mode in the slave microprocessor 18 (step S4). The slave microprocessor 18 then requests the first codeword from the master microprocessor 16, which then transfers this to the slave microprocessor 18 (step S5).

When the first codeword has been verified by the slave microprocessor 18, said microprocessor then requests a second codeword from the master microprocessor 16 (step S6). The master microprocessor 16 then requests the second codeword from the diagnostics unit 12 (step S7). After the second codeword has been transmitted from the diagnostics unit 12 to the master microprocessor 16, and has been checked by said microprocessor, it transmits the second codeword to the slave microprocessor 18 in a second step S8.

The slave microprocessor 18 then checks the first and second codeword by logically connecting the two codewords and testing the validity of the result. If the check shows that both codewords are correct, the slave microprocessor 18 releases the firing (step S9). The master microprocessor 16 confirms the release (step S10) and in turn releases the firing path. The slave microprocessor 18 then releases the firing path (step S11) and sends acknowledgement of the release to the master microprocessor 16 (step S12). The master microprocessor 16 then fires the primer 10 and monitors and logs the firing procedure and the firing circuits to ensure that the firing is conducted correctly. Confirmation of the successful firing procedure is then sent by the master microprocessor 16 to the diagnostics unit 12 (step S13). The master microprocessor 16 then blocks the airbag system (step S14).

The procedure described above offers the maximum in security, and works with standard diagnostics units. In order to implement the invention, it is only necessary, in the simplest scenario, to adapt the operating software of the diagnostics unit and the airbag system, specifically to supplement them with the disposal mode.

After firing, the safety system with the primer, such as an airbag system, can be dismantled without any risk of danger.

### REFERENCE NUMERALS

10 Primer (pyrotechnical actuator)
12 Diagnostics unit
14 Airbag control unit
16 Master microprocessor
18 Slave microprocessor
20 Firing path
22 Acceleration sensor
24 Diagnostics interface
26 Data bus
28 First activation signal
30 Second activation signal
32 Firing path switch
34 Driver stage
S1-S14 Procedural steps

1-17. (canceled)

18. A method for deactivating a pyrotechnical actuator (10) from a vehicle, the method comprising:
activating a diagnostics mode of a control unit (14) (S0, S1) by using a diagnostics unit (12);
activating a disposal mode in the control unit (14); and
firing a pyrotechnical actuator (10) is fired in the dispoal mode.

19. A method according to claim 18, wherein in the disposal mode, a master controller (16) in the control unit (14) receives a first codeword for firing the pyrotechnical actuator (10) from the diagnostics unit (12) (S3), the master control then transfers the first codeword to a slave controller (18) (S5), which is provided in order to release and lock a firing path (20) of the pyrotechnical actuator (10) (S1).

20. A method according to claim 19, wherein the slave controller (18) requests a second codeword to fire the pyrotechnical actuator (10) from the master controller (16) (S6), and the master controller (16) requests the second codeword from the diagnostics unit (12) (S6).

21. A method according to claim 20, wherein the master controller (16) requests the second codeword from the diagnostics unit (12) during a prespecified time period.

22. A method according to claim 21, wherein the disposal mode is deactivated if the diagnostics unit (12) transfers no second codeword to the master controller after the prespecified time period has elapsed.

23. A method according to claim 19, wherein the slave controller (18) checks the first and second codeword, specifically linking both codewords with each other, and tests the validity of the result.

24. A method according to one of claims 23, wherein the slave controller (18) transmits a release signal to the master controller (16) when the two codewords have been checked successfully.

25. A method according to claim 24, wherein the master controller (16) sends an acknowledgement that the release signal has been received to the slave controller (18) and releases the firing path (20) of the pyrotechnical actuator (10).

26. A method according to claim 25, wherein the slave controller (18) releases the firing path (20) of the pyrotechnical actuator (10) after the master controller (16) has acknowledged the release signal.

27. A method according to claim 26, wherein the master controller (16) monitors firing circuits for firing the pyrotechnical actuator (10) to ensure that the firing is being conducted correctly, and which logs the firing of the pyrotechnical actuator (10).

28. A method according to claim 27, wherein a system incorporated into the fired pyrotechnical actuator (10), specifically an airbag system, is locked (S14).

29. A method according to claim 28, wherein when the system is locked, a date and/or time stamp, and/or an identification, specifically the identification number of the diagnostics unit (12) is stored in the system.

30. A method according to claim 28, wherein the diagnostics unit (12) issues, and specifically prints out, a protocol after the system is locked, which comprises at least one of a vehicle serial number, a system serial number, or a status of the system with the pyrotechnical actuator.

31. A device for deactivating a pyrotechnical actuator (10) from a vehicle, the device comprising:
a control unit (14) for controlling the pyrotechnical actuator (10), wherein the control unit (14) comprises a disposal mode which is provided in order to fire the pyrotechnical actuator (10) in a controlled manner; and
a diagnostics unit (12) which is designed for activating a diagnostic mode in the control unit (14) of the pyrotechnical actuator (10), wherein the diagnostics unit (12) is designed to activate the disposal mode of the control unit (14) of the pyrotechnical actuator (10).

32. A device according to claim 31, wherein the control unit (14) and the diagnostics unit (12) are designed for conducting a procedure for deactivating a pyrotechnical actuator (10) from a vehicle, the method comprising:
activating a diagnostics mode of a control unit (14) (S0, S1) by using a diagnostics unit (12);
activating a disposal mode in the control unit (14); and
firing a pyrotechnical actuator (10) is fired in the dispoal mode.

33. A device according to claim 31, wherein the control unit (14) and the diagnostics unit (12) are equipped with a program for deactivating a pyrotechnical actuator (10) from a vehicle, the method comprising:
activating a diagnostics mode of a control unit (14) (S0, S1) by using a diagnostics unit (12);
activating a disposal mode in the control unit (14); and
firing a pyrotechnical actuator (10) is fired in the dispoal mode.

34. An airbag system comprising:
a pyrotechnical actuator (10) for activating an airbag; and
a control unit (14) to control the airbag system, specifically to monitor and fire the pyrotechnical actuator (10), wherein the control unit (14) comprises a disposal mode in order to conduct the firing of the pyrotechnical actuator (10) in a controlled manner, which can be activated by a diagnostics unit (12).
